(19) United States
(12) Patent Application Publication
(10) Pub. No.: US 2007/0178428 A1
(43) Pub. Date: Aug. 2, 2007

(54) Method for prognostication the behavior of a man and/or type of his/her activity and also for identification of his/her personality

(76) Inventors: Mark Luchin, Tallinn (EE); Nelli Vakhterova, Tallinn (EE)

Correspondence Address: ROTHWELL, FIGG, ERNST & MANBECK, P.C., 1425 K STREET, N.W., SUITE 800, WASHINGTON, DC, 20005, US

(21) Appl. No.: 10/873,636

(22) Filed: Jun. 23, 2004

(30) Foreign Application Priority Data
Jun. 24, 2003 (RU) 2003119530

(51) Int. Cl. G09B 19/00

(52) U.S. Cl. 434/238

(57) ABSTRACT

A method for prognosticating behavior and/or activity type of a person and for identifying person, by ascertainment of the psycho-physiological parameters of the phenotype. The invention relates to the field of training and personnel management. It can be applied in medicine and criminology, for example it enables to generate the phenotype parameters (to create a photo-robot, for example, an identikit) proceeding from the known or those being of interest psychological special character traits. The novelty is that the measuring of at least one parameter of a part of the phenotype of a certain person is carried out, then the obtained data are correlated, for example, by simulation (creating a model), with the psychophysiological and/or physical possibilities of fulfilling the functions, which can be realized by this part of the phenotype, and then a conclusion is drawn on the basis of the obtained results about the predisposition of the individual to the corresponding type of behavior, to the corresponding type of activity and to development of corresponding compensating social-and-psychological traits. This makes it possible in each individual case to form a high-quality unique characteristic of an individual, since a great number of individually specified phenotype parameters (in some cases amounting to 140), their physiological functions and their combinations are taken into consideration.

### FIELD OF THE INVENTION

The present invention relates to the field of training and personnel management, and in particular it concerns a method for prognosticating behavior and activity type of a person and for identifying personality. The invention is also applicable in medicine and criminology fields.

### BRIEF DESCRIPTION OF THE BACKGROUND ART

A problem of ascertainment of behavior type of a person on the basis of a certain phenotype is considered to mainly consist of the following questions: availability of signs, their clarity, exactness and semantic distinctness. At present, no reliable procedures to ascertain real psyche type of a person are available in typology. It is considered to be unlikely in general because a human being is too complicated. This is why various obscure procedures that are incapable to give any high-quality, iterative and standardizable results have been constantly appearing. In the field of temperament, which is mainly determined by constitutional characteristics, the majority of authors distinguish at most three or four types (see a table of comparison by J. Strelyau in Table 1).

TABLE 1
Comparison of Some Temperament Typologies

| Typology | | | | |
|---|---|---|---|---|
| author | Temperament type | | | |
| Hippocrates- | Sanguine | Phlegmatic | Choleric | Melancholic |
| Galenus | | | | |
| E. Kretschmer | Cyclothymic | Iksothymic | — | Shizothymic |
| U. Sheldon | Visceral | — | Somatic | Cerebral |
| K. Conrad | Cyclothymic | Viscose | Spiritualistic | Shizothymic |
| I. Pavlov | Strong | Strong | Strong | Weak |
| | balanced | balanced | unbalanced | |
| | mobile | inert | | |

One can see from the above definitions that typology concept is strictly connected with some definite set of characteristics. Whereas there exist tens of thousands human types in reality, this fact is absolutely not considered by the contemporary science.

E. Kretschmer, an outstanding representative of constitutional direction, distinguished and described four most frequent types of body structure, or constitution of the man. In accordance with build type (by phenotype), Kretschmer distinguished only three basic types of temperament. Besides, he attempted to explain behavior of the man via his build type. It resulted in a conclusion about some connection between the constitution of a man and susceptibility to mental diseases. However, Kretschmer had no scientifically valid physiological proofs, though common practical experience indicates to a definite correlation between character type of the man and his build. Thus, people with a specific build demonstrate accentuation of the corresponding character traits. Neither had Kretschmer any detailed physiological procedure for systematization of phenotype parts. He had distinguished and described three most frequent types (phenotypes) of body structure and constitution of a man: asthenic, athletic and pyknic, and related each one to separate character type.

The asthenic type is characterized by minor corpulence of a man in profile on the background of medium or above-medium height. As a rule, an asthenic is lean or thin, and seems somewhat higher than actually because of leanness. An asthenic has thin face and body skin, narrow shoulders, thin hands, elongated and flat thorax with the poor developed muscular system and weak adipose matter accumulation.

An athletic type is characterized by a well-developed skeleton and muscular system. Usually an athletic is medium-height or tall, has wide shoulders, a strong thorax and a solid high-seated head.

A pyknic type is characterized by developed internal body cavities and a tendency toward adiposity on the background of poor developed muscles and supporting-motor apparatus. A pyknic is of medium height and has a short neck, which is low-seated between shoulders.

As already shown by Kretschmer and partly confirmed by the latest studies in the psychogenetics field, a body structure type correlates in some way with susceptibility to mental diseases. In Kretschmer's opinion, diseases are “caricatures of definite normal personality types”. Kretschmer named “the shizothymics” that type of normal people who resemble schizophrenics by their psychological peculiarities and “the cyclothymics” those resembling the patients suffering from manic-depressive psychosis. “The shizothymics” are characteristic of such character traits as aristocracity and subtlety, tendency toward the abstract reflections and aloofness, coldness, selfishness, imperiousness, dryness and lack of emotions. Kretschmer described “the cyclothymics” as persons who are cheerful, talkative, careless, warm-hearted, energetic, inclined to humor and with easy perception of life.

Censorious remarks about Kretschmer's ideas are abundant, though the confirmable results are more numerous. Nevertheless, the authors of the present invention consider the conclusion made by one of investigators working in the field of typology, I. Lange, to be by far more important. He paid attention to the statistical unauthenticity of the percentage of the results of studies based on generalized phenotype signs of the man (Carmelli, D., Cardan, L. R., Fabsitz, R. Clustering of hypertension, diabetes, and obesity in adult male twins: same genes or same environments? //Am. J. Hum. Genet. 1994. V. 55. No. 3. P. 566-573). Other studies were carried out, too, for example, about informative morphogenetical variations of the man (acc. to Cohen, M. M., 1997).

Thus, the above broad polymorphism of phenotype signs in syndrome studying is presented by separate discrete and reiterative complexes, which are combined with certain pathologies of various organs and systems (Gorlin, R. J., Toriello, H. V., Cohen, M. M. Hereditary Hearing Loss and Its Syndromes.—New York, Oxford : Oxford University Press, 1995. P. 457).

However, the above methodology, though operating with phenotype, could not formulate a clear concept about supposed nature and possible inclinations of a person to certain actions or states. Although the phenotype, which is understood as peculiarities of build, and details of head, body and extremities structure, is well known to anthropologists. The informative morphogenetical variations and minor anomalies of development are the anomalous morphology variations of single organs or tissues, which are not important from the point of view of medicine, i.e., they do not need any medical treatment. These variations are believed to arouse in connection with embryonal or, rarely, with fetal period of morphogenesis of the man (Eisman, J. A. Vitamin D receptor gene alleles and osteoporosis: an affirmative view //J. Bone Miner. Res. 1995. V.10, No. 9. P. 1289-1293). The only reliable data obtained were that the head, region of neck and hands are most informative with respect to these signs, and more than 70% of all minor anomalies of development are located in those very regions (Cohen, M. M., Jr. The Child with Multiple Birth Defects (2nd ed.).- New York: Oxford University Press, 1997. P. 267). Yet, what is more important for the authors of the present invention, is Charles Darwin's well substantiated concept that the signs being of minor vital importance for the species are most significant for the taxonomist and such a high importance of inessential signs with respect to classification depends mainly on their correlation with other signs, which are more or less essential. As for significance of the complex of signs for the natural history, it is quite obvious. ( [symbol] [symbol] [symbol] [symbol] [symbol] [symbol] TOM 1. ( [symbol] [symbol] [symbol] ). —C.— [symbol] , 1874. C. 9-21[Darwin, Ch. Origin of the Man and Selection with Respect to Sex. Vol. 1. (translated by I. M. Sechenov).—St.-Petersburg, 1874. P. 9-21]).

It is known, that “by analogy with the syndrome approach in clinical genetics, it is possible to select and study the adaptive phenotypes of the man among representatives of extreme professions, as well as among patients suffering from widespread diseases, such as atherosclerosis, hypertension, diabetes mellitus, heart ischaemia, etc. Concerning the first group, it gives real possibilities for most effective occupational selection . . . ” ( [symbol] , [symbol] ,C.B. [symbol] [symbol] [symbol] - [symbol] , 1986. C. 119. [Kaznachejev, V. P., Kaznachejev, S. V. Adaptation and Constitution of the Man.—Novosibirsk, 1986. P. 119, in Russian]).

Representatives of extreme professions and patients suffering from widespread diseases have similar mechanisms of adaptive reactions in response to stress factor effects. Therefore replacing the clinical manifestations with the “individual adaptive norm of reaction” in the structure of nosologic syndrome (syndrome is a complex of clinical picture and phenotype) is quite reasonable (acc. to Shmalgauzen). According to contemporary concepts, individual adaptive norm of reaction is manifested via mechanisms of the “general-adaptation syndrome” (acc. to Selye) (Slemenda, C. W., Christian, J. C., Williams, C. J. et. al. Genetic determinants of bone mass in adult women: a re-evaluation of the twin model and the potential importance of gene interaction on heritability estimates//J. Bone Miner. Res. 1991. Vol. 6, No. 6. P. 561-567).

Each level of biological organization, metabolism, tissue, organ and region levels, or their combination give rise to the appropriate syndrome of multiple congenital defects: dysmetabolism syndrome, dysplasia syndrome, congenital malformation syndrome (syndrome of congenital defect of development) and deformation syndrome. The adaptive phenotypes of a person form in compliance with this organization, but with no congenital malformation and with informative morphogenetic variations only, combined with mechanism of “general-adaptation syndrome”. This is proven by analogous twin researches with respect to some physiological parameters of human organism. Thus, high genetic determination of numerous electroencephalogram indications is well known (Wertelecki, W Dermatoglyphics. In: Human Malformations and Related Anomalies. Vol. 2 (R. E. Stevenson, J. G. Hall and R. M. Goodman eds.). New York, Oxford : Oxford University Press. 1993. P. 999-1016). Examination of 43 newborn twin pairs has shown a considerably high concordance of M3 twins on the basis of sensitivity of the peripheral chemoreceptors to oxygen stimulation (Tokita, A., Kelly, P. J., Nguyen, T. V. et al. Genetic influences on type I collagen synthesis and degradation: further evidence for genetic regulation of bone turnover//J. Clin. Endocrinol. Metab. 1994. Vol. 78, No. 6. P.1461-1466).

Discretion and reiteration of the “adaptive norm of reaction” is a basic and fundamental point in the methodology of adaptive phenotypes of the man. The number of that kind of adaptive phenotypes is large enough and, evidently, it considerably exceeds the number of nosologic syndromes in clinical genetics, whose number, as it is known, exceeds 3000 diagnoses. Attempting to distinguish all of adaptive phenotypes of a man is an extremely difficult and obviously unsolvable problem. Nevertheless, knowing these phenotypes, having most favorable adaptive characteristics for certain professional activity, will provide optimization of occupational selection. ( [symbol] , [symbol] , [symbol] [symbol] [symbol] [symbol] [symbol] [symbol] // [symbol] [symbol] [symbol] [symbol] [symbol] 1999, T. 30, No. 2, C. 50-62. [symbol] [symbol] [symbol] [symbol] [symbol] [symbol] M3 [symbol] [symbol] [symbol] [symbol] [symbol] [symbol] [Delone, N. L., Solonichenko, V. G. Adaptive phenotypes of the man in physiology and medicine//The Russian Academy of Sciences. Successes of Physiological Sciences. 1999. Vol. 30, No. 2. P. 50-62. The State Scientific Center for Medical-and-Biological Problems; Ministry of Health of Russian Federation, N. F. Filatov Medicogenetic Center, UDC index 612.6.05.06:629.78.08 Children's Clinical Hospital, Moscow [in Russian]).

The well-known principles listed above concern the method for prognosticating behavior and/or activity type of a man (further also ‘person’, ‘individual’) and/or for identifying personality, comprising the steps of parametric analysis of the phenotype of a person and drawing conclusion on the basis of the results obtained. However, according to this method, medical parameters or some other complex-and-empirical parameters that are found at best randomly and often have no scientific physiological grounds are selected.

Besides, the known method cannot be used to prognosticate behavior and/or activity type, neither to identify personality of a man characterized by certain signs of phenotype. This demerit is caused by the following. According to this method, either medical parameters, which-are possible to connect with certain pathologies but not with phenotype nature, or medical parameters, which are connected with phenotype character but those being extraordinary complex and additionally having pathologic properties, are selected. Or alternatively, empirical-and-complex parameters of phenotype and labeling the relatively similar complexes with standard names including from 4 to 16 psychotypes are used. This does not allow obtaining precise conclusions about possible behavior of a person by the phenotype thereof. Furthermore, the selected parameter complexes are not directly connected with psychophysiological features of each specific part of phenotype, and especially with peculiarity of functions carried out by this part.

Besides, the authors and followers of the typology, reducing the unique peculiarity of each phenotype to 4-16 types, do not account for the fact that even the number of nationalities in the world is no less than 955 ( [symbol] [symbol] [symbol] [symbol] [symbol] [symbol] [symbol] [symbol] 7 [symbol] 9 [symbol] [symbol] [symbol] 6 [symbol] B [symbol] [symbol] [symbol] [symbol] [symbol] [symbol] [symbol] [symbol] [symbol] No. 171 Feb. 9 2002./ [symbol] [symbol] [symbol] [symbol] [symbol] [symbol] 2002, . [The alphabetical list of nationalities and languages for coding the answers to questions 7 and 9 of the forms K and D and to question 6 of the form B of the all-Russian population census, approved Feb. 9, 2002 by the Resolution of the State Committee of Statistics of Russian Federation No. 171, Moscow, 2002]). Moreover, each nationality has its own characteristic peculiarities in the field of culture, habitat, phenotype and physiology and, consequently, in behavioral reactions as well.

### SUMMARY OF THE INVENTION

The object of the present invention is to create a new method for prognosticating behavior and/or activity type of a person and also for identifying personality, in which the parameters of any part of phenotype would be integrally bound with their functional psychophysiological possibilities, to provide more reliable results being obtained.

The above-mentioned object of the invention is met by the method for prognosticating behavior and/or activity type of a person and/or for identifying personality, which includes parametric analysis of the phenotype of a person and concluding on the basis of the results obtained, and which comprises (according to the present invention)
measuring at least one parameter of any part of the phenotype;
and correlating the results of measuring, at least by means of simulation (creating the model), with psycho-physiological and/or physical possibilities of said part of the phenotype to fulfill at least one function which can be realized by said part of phenotype;
and concluding is done on the basis of results of said correlating and about predisposition of said person to certain type of behavior, and/or to forming certain compensatory social-and-psycological traits of character, and/or to certain type of activity.

The object of the present invention is also met by the method for prognosticating behavior and/or activity type of a person and/or for identifying personality, which comprises
measuring at least two parameters of at least one part of phenotype;
and comparing the results of correlating the results of measuring said parameters of at least one part of phenotype with possibilities of said part of phenotype to fulfill at least one function which can be realized by said part;
and concluding is done on the basis of the results of said comparing.

Besides that, the object of the present invention is met by that the method for prognosticating behavior and/or activity type of a person and/or for identifying person, comprises
measuring at least one parameter of phenotype of representatives of at least one population group;
and concluding is done about predisposition of said population group to certain type of behavior, and/or to forming certain compensatory social-and-psycological traits of character, and/or to certain type of activity.

A technical solution, according to the present invention, makes it possible to obtain a new method, according to which the accuracy and reliability of the results obtained at determination of possible behavior of a person or type of its activity, and also at identification of its personality on the basis of the phenotype thereof depends directly on both measurements of the phenotype parts and their connection with psychophysiological functions that are realized by those parts. As shown by the authors'/applicants'investigations, which include calculations and experiments, an actual number of psychotypes exceeds 10³⁰. This evidences the presence of a unique individuality in each person and the impossibility to correctly enter the personality into a predetermined and limited number of types. Thus, the types existing up to now cannot be used to create even a descriptive characteristic of entire populations, all the more to obtain a precise and objective personal characteristics of a concrete phenotype.

In comparison with the known method, the present invention has essential differences, which make it possible to form in each separate case a unique characteristic, which is inherent to a concrete phenotype only, in its true value, since many individually expressed parameters of the phenotype and their psychophysiological functions are taken into consideration. Thus, a possibility to obtain a sufficiently precise descriptive characteristic of behavior and corresponding social-and-compensating traits of entire population groups occurs.

The analysis of the scientific-and-technical and patent information carried out by the authors of the present invention demonstrated that the claimed totality of the essential distinctive features was not known before. Consequently, the present invention can be considered to be new.

The present technical solution has the inventive level, since for a person skilled in the art this technical solution does not evidently follow from the prior art, first of all because the present technical solution considers a large number of discrete parameters of various parts of phenotype and their psychophysiological functions.

### BRIEF DESCRIPTION OF THE DRAWINGS

The present invention is clarified by the diagrams (FIG. 1-FIG. 5) and by the following description of the examples of realization of the invention.

FIG. 1—a model of the phenotype of head and shoulder girdle of a short-neck man.

FIG. 2—a model of the phenotype of head of a man, whose nose is longer than his ear.

FIG. 3—a model of the phenotype of nose, a view in section in the head symmetry plane.

FIG. 4—a model of the phenotype of a specifically-shaped ear.

FIG. 5—an acoustic-frequency characteristic of scanning the phenotype of a specifically-shaped ear.

### EXAMPLES OF REALIZATION OF THE METHOD ACCORDING TO THE PRESENT INVENTION

In 1994, to test the present method, which was under development then, the authors of the invention used it to analyze a number of individuals with the purpose to solve some manpower-policy questions and to improve the quality of staff recruitment for a collecting agency that belonged to the international security firm “Securitas AB”. For primary analysis photos of three employees were used.

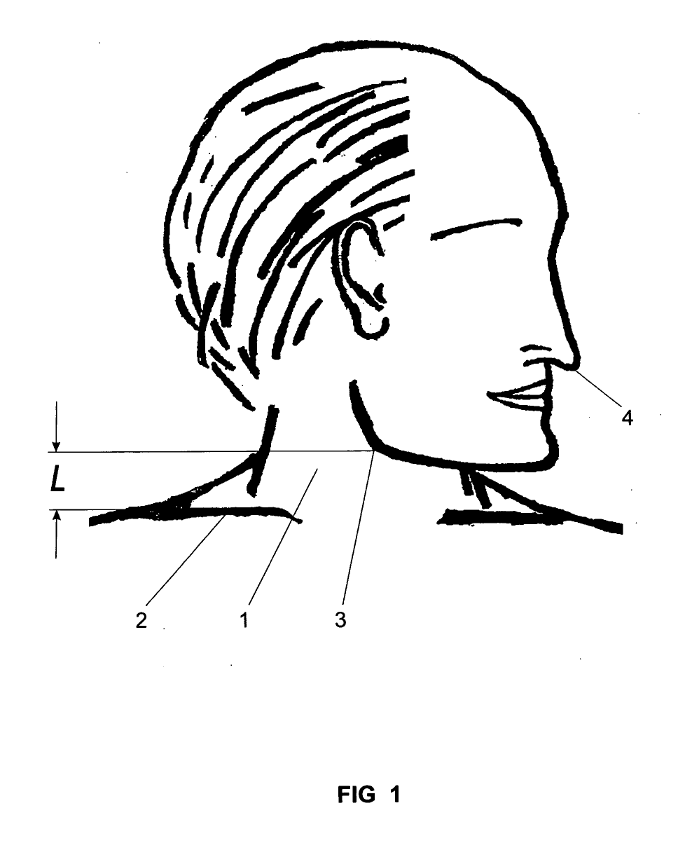

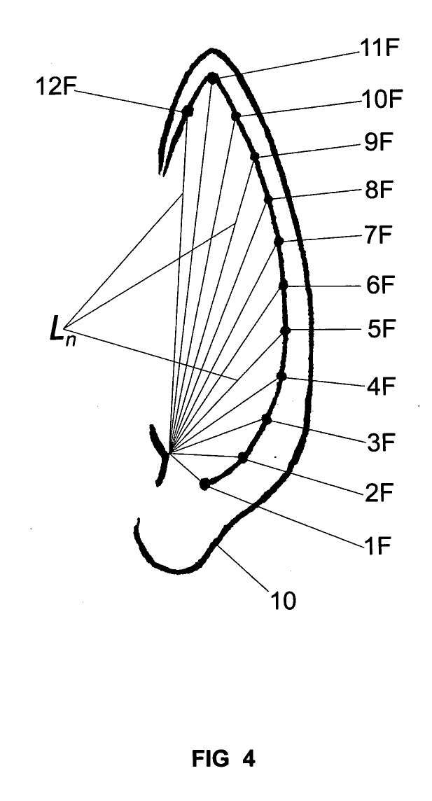

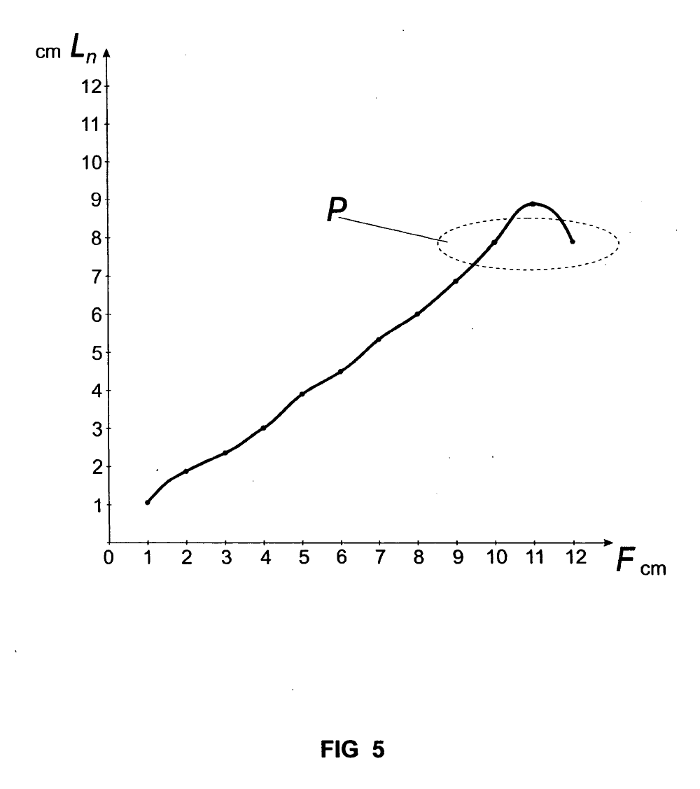

The legend used in the description and diagrams (FIG. 1-FIG. 5) are as follows: 1—neck, 2—collarbone, 3—lower jawbone bend, 4—nose tip, 5—articulation point of nose bridge and superciliary arch, 6—lower point of ear lobe, 7—upper point of auricle, 8—mixing cavity, 9—end part of nose, 10—ear, as well as
L [cm]—neck 1 length, which is equal to the distance from the collarbone 2 to the lower jawbone bend 3;
L₁[cm]—nose length, which is equal to the distance from the nose tip 4 to the articulation point 5 of nose bridge and superciliary arch;
L₂[cm]—auricle length, which is equal to the distance from the lower point 6 of the ear lobe to the upper point 7 of auricle;
Lₙ[cm]—acoustic-frequency characteristic of scanning the phenotype of ear (shows the distance from the ear acoustic duct center to the outer contour of the concha auriculae, wherein said distance is measured for a set of subsequent points situated longwise the said contour with spacing of 1 cm between each two neighbouring measurement points) (FIG. 5);
F [cm]—distance lengthwise the outer contour of the concha auriculae (FIG. 4);
1F-12F—set of auricle parameter measuring points situated lengthwise the outer contour of the concha auriculae (FIG. 4);
P [cm]—zone of parasitic oscillation of the acoustic-frequency characteristic of scanning the phenotype of ear (Lₙ) (FIG. 5).

### EXAMPLE NO. 1

### Individual No. 1—a Short-Neck Phenotype

Neck 1 length L was measured as the distance from collarbone 2 to lower jawbone bend 3 (FIG. 1). L was found to be somewhat shorter than 7 cm. The result obtained was correlated by simulation (creating the model) with psychophysiological parameters of the neck 1 functions. From physiology standpoint, a short-neck individual has short neck arteries. The neck artery functions as a buffer system, which softens the impact blood overshoots that are directed from the heart to the brain. In stress condition under the influence of neurohumoral factor, the intense heart contractions transfer the shock pulsatory loads to the brain via blood, since in this case the overshoots of blood from the heart are not sufficiently lessened by the buffer system of this phenotype's carotids because of their short length. Basing on the experiments carried out and the simulation performed, the authors of the invention have found that in this condition the brain attempts to weaken the palpitation via the heart muscle sections innervated by the brain. However, since the heart is mainly innervated by itself (by the autonomous nervous elements of the heart), and its functioning is sufficiently autonomous, the brain influence both weakens and complicates the functioning of heart which is already extra-loaded being in stress condition. Also, it was determined and experimentally confirmed that the short-neck people are not sufficiently tolerant to stresses and cannot timely produce an adaptive reaction to changing social-and-psychological conditions. Hereat, conservatism and low-initiative traits are formed in such individuals as a psychological-defense compensatory mechanism. This is an extremely favorable combination for sedentary jobs which require permanent being in a bounded space (for example, in the office). Basing on the results of application of the present method in this Example, authors concluded that from the standpoint of physiology, for the individual under examination the occupation requiring no manifestation of high initiative, in particular with no frequent trips, is the optimum kind of job. To determine the tendency toward certain activity more precisely, more complete examination of an individual is needed, for example, basing on several parameters of phenotype in accordance to the claim 2 of the claims of the present invention.

### EXAMPLE NO. 2

### Individual No. 2—a Long-Neck Phenotype with Relatively Long Nose Being Longer than the Ear

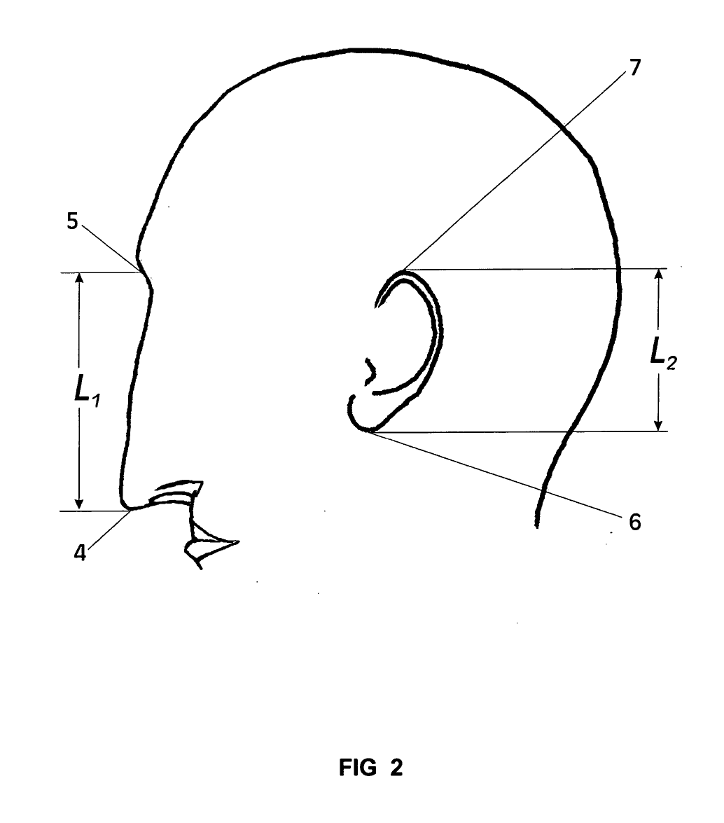

Neck length L (FIG. 1), nose length L₁ (FIG. 2), and auricle length L₂ (FIG. 2) were measured. The nose length Li was measured as the distance from the nose tip 4 to the articulation point 5 of nose bridge and superciliary arch. The auricle length L₂ was measured as the distance from the lower point 6 of ear lobe to the upper point 7 of auricle. According to measuring results, the neck length L was somewhat longer than 13 cm (the long-neck phenotype), the nose length L₁ equaled 10 cm (the long-nose phenotype), and the auricle length L₂ equaled 7 cm. The nose length L₁ was compared with the auricle length L₂. The nose was found to be about 3 cm longer than the ear, i.e. the nose length L₁ manifestly exceeded the auricle length L₂. By their psychophysiological properties long-neck individuals have longer neck arteries. The neck arteries function as buffer system, which softens the impact blood overshoots that are directed from the heart to the brain. In stress condition under the influence of neurohumoral factor, the intense heart contractions are well damped and practically do not transfer the critical shock pulsatory loads to the brain. Resulting from it, the authors of the invention have established that in this situation the brain does not attempt to considerably interfere the heart functioning via the muscle sections of the heart innervated by the brain, and thus does not prevent the normal functioning of the heart under increased load. It was established and experimentally confirmed by the authors that the long-neck individuals never form such traits as conservatism, low initiative, insufficient tolerance to stresses and delayed adaptive reaction to changing social-and-psychological conditions as a psychological-defense compensatory mechanism. On the contrary, such individuals are extensively ready to perceive innovations, they are well-tolerable to stresses and withstand occupations requiring permanent physical motion, business trips, and creative search with sufficient comfort and ease. Also, basing on earlier investigations and experiments it was established that from the psychophysiological standpoint the long-nose individuals have a well-developed system for obtaining the smell signals. Physiologically well-developed organ is capable to function more effectively then other ones. As the relatively-long-nose phenotype whose nose is longer than the ear is under discussion, among the signals received from the environment through the ear, eyes and nose, in the case in question it is the nose to be the prevailing system of information. It is normal from a psychophysiological point of view. According to the rule of substitution of functions, individuals of this type are to a great extent inclined to perceive the outward things mainly by way of emotional-and-sensual criteria and not through the boring specific analytical and intellectual theses and aims. And first of all, this predetermines high-degree emotional-and-perceptional reactions of the individual. Authors have established that in stress condition individuals with long nose being longer than the ear, often switch unwittingly from the logical evaluation of events to the perceptional one. It was established and experimentally confirmed that individuals with long nose being longer than the ear form such traits as gift for fine arts, inclination to aesthetical perception and higher tact as a psychological-defense compensatory mechanism, and they are characterized by greater thoughtfulness, prolonged process of making decisions, and sometimes sluggishness. An additional analysis carried out in the context of the present invention showed that from psychophysiological standpoint, most preferable occupation for that kind of individuals is a labor, which requires the combination of high initiative, inclination to innovations and lack of conservatism on the background of high emotionality. Combination of these characteristics directs the psychophysiology of the man to creative sensual search combined with the desire to sense own significance and innovation. In particular, a possible profession for the individual in question is occupation in the field of design, style, search for new creative methods of thinking, and also managing a creative group, etc. Nevertheless, to more precisely ascertain the individual's inclination to some certain type of activity, it is needed to more entirely examine the individual by measuring and correlating a sufficient number of phenotype parameters and also to account for the training and education level of the person.

### EXAMPLE NO. 3.

### Individual No. 3—the Phenotype with a Relatively Long Neck, Poor Developed Mixing Cavities of the Nose, and Specifically-Shaped Ear

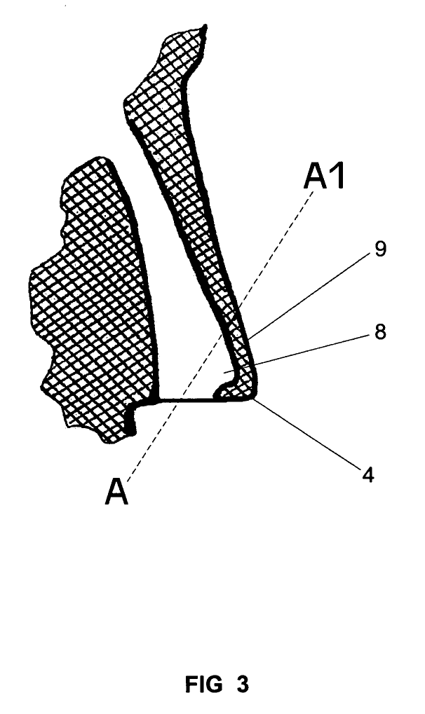

Neck length L (FIG. 1), nose (FIG. 3) and ear (FIG. 4, FIG. 5) parameters were measured. The neck length L was found to be relatively long- exceeding 14 cm. Measuring of the nose parameters had shown that the phenotype investigated had poor developed mixing cavities 8 of nose, i.e. thin and sharp nose end part 9 (FIG. 3). Measurements of the nose are carried out on the “segment” of the end part 9 of the nose which is cut off by the secant plane A-A1, passing through the mixing cavities 8 at a distance of 4-15 mm deep from the tip 4 of the nose (FIG. 3), the distance depending upon the age and the individual parameters of the person. This phenotype also had specifically-shaped ears 10 (FIG. 4). The measurements of ear were made by modelling (simulating) it on a plane with the subsequent acoustic-frequency scanning the ear phenotype lengthwise the outer contour of the concha auriculae with spacing of 1 cm (points 1F-12F in FIG. 4). The acoustic-frequency characteristic Lₙ of scanning the ear phenotype is shown in FIG. 5. It can be seen from the diagram in FIG. 5, that form specificity of this ear is manifested by rather narrow zone P of parasitic iterative oscillations and wide range of the oscillations perceived. The neck length L was correlated with the size of the end part 9 of the nose (FIG. 3), and also with the ear form (FIG. 4) in conjunction with the acoustic-frequency characteristic of scanning the phenotype of ear (FIG. 5), by their simulation (creating the model) with psychophysiological and physical possibilities of all phenotype parts mentioned above to fulfill their functions. Basing on the experiments carried out and the simulation performed the authors of the invention concluded that individuals with long neck, sharp end part of nose and specifically-shaped ear (as shown in FIG. 4) are psychophysiologically predisposed to pedantry, high-intellectual load, high initiative, etc. The conclusion is based on the following.

From physiology standpoint, a long-neck individual has also longer neck arteries. The neck arteries function as a buffer system, which softens the impact blood overshoots that are directed from the heart to the brain. In stress condition under the influence of neurohumoral factor, the intense heart contractions are well dumped and practically do not transfer the shock pulsatory loads to the brain. The authors found that in this condition the brain does not attempt to considerably interfere the heart functioning via the heart muscle sections innervated by the brain and thus it does not prevent the normal work of heart under the increased load. Authors of the invention established and experimentally confirmed that in long-neck individuals no such traits as conservatism, low initiative, insufficient tolerance to stresses and delayed adaptive reaction to the changing social-and-psychological conditions are formed as a psychological-defense compensatory mechanism. On the contrary, such individuals are extremely ready to perceive innovations, they are well-tolerable to stresses and withstand occupations requiring permanent physical motion, business trips, and creative search with sufficient comfort.

that, basing on previous investigations and experiments the authors established that from the psychophysiological standpoint the individuals whose mixing cavities of nose are poor developed in nose end part (a case of the sharp nose) are highly capable to punctually and in detail analyze the entering smell signals. With time their habit to detail and keen discrete perception transforms into a general habit and tendency to more perfect and pedantic reaction to environment. Since physiologically the highly-sharp end part of nose (poor developed mixing cavities of the nose) does not sufficiently warm and mix up the entering air, the receptors of olfactory epithelium contact with the air, which is insufficiently mixed, and characterized with wide temperature gradient and discreteness of smells. From psychophysiological standpoint, the signals coming with such an airflow also are more diverse and detailed. Psychophysiologically, it shapes the individual to more pedantic and keen analytical perception. For instance, the authors established and experimentally confirmed that in the individuals with a sharp end part of nose (poor developed nose mixing cavities), such features as inclination to pedantry and detail elaboration to the extent of meticulousness are developed as a psychological-defense compensatory mechanism. It is an extremely favorable combination of features that are needed for professions, which require pedantry, scrupulousness, accuracy and tendency to carry work through, for example, experts, inspectors, auditors, investigators, book-keepers, etc.

In terms of physics and physiology, as well as neurophysiology, the concha auriculae is an antenna receiving sound vibrations in a frequency range approximately from 16 Hz to 31 kHz. At that, when entering the inner ear, which serves as a receiver, the signals of the above frequencies are converted (at neurophysiological level) into electric signals, that together with other neurophysiological signals enter the brain of the individual for further analysis. Also, the fact was considered that together with other most important sources of neurophysiological signals (the nose and the eyes) the ear is in fact a permanently connected source of brain intellectual loads. It is also confirmed by the problem of development of intellectual facilities of those being deaf from birth. It is known that high-quality signal recept is extremely dependant on the antenna ability to cover the possibly widest frequency band with no dead spots and parasitic reiterations. In the present case, the acoustic-frequency characteristic of scanning the phenotype of a specifically-shaped ear (FIG. 5) reflects the high qualities of the ear as antenna (FIG. 4). Herein, as seen from the diagram, a zone of parasitic iterative oscillations P is narrow, whereas the range of the oscillations perceptible is wide. This enables the authors to assume with a great likelihood, basing on the investigations performed, that the brain of the discussed individual had been permanently trained in processing a complex broad-band signal, and because of that the said individual is psychophysiologically adjusted to effective training and to highly-intellectual development, the latter, nevertheless, may be lacking due to the influence of social factors and absence of the proper education. As a result, this phenotype is most adjusted to initiatively and pedantically manifest its intellect. Therefore it is absolutely ineffective to use the individuals of that kind for sedentary motionless work, as well as for work not requiring pedantry, accuracy or for primitive work. It is completely confirmed by long-term experiments carried out by the authors of the invention. Thus, to clarify the individual's inclination to certain kind of activity more exactly, more complete inspection of a person is needed, including, in particular, choice and considering a greater number of metric parameters of various psychophysiological functional parts of the phenotype, construction of their models and comparison of the models with each other. The authors use at least 140 parts of the phenotype that are correlated with their psychophysiological functional abilities and corresponding social-and-psychological character traits.

The results obtained using the present method are highly adequate and do not depend on the phenotype national or race identity. Due to this the result obtained is always particularly individual and objective.

The above-mentioned number of discrete psychotypes, actually exceeding 1030, shows that each person has a unique individuality. This testifies the impossibility to correctly enter a certain individual into the predetermined limited number of types. However, in the opinion of the authors of the invention, in the method according to the present invention for the first time it was a success to bring into correlation the phenotype metric parameters as well as their physiological functional destination, with psychophysiological manifestations in the field of character, predisposition of the individual to a certain type of behavior and to developing the corresponding compensatory social-and-psychological character traits and to certain kind of activity. Therefore the method according to the present invention can be considered as a cornerstone for a new psychophysiological methodology for investigating the human activity.

Also, the present method makes it possible to generate the phenotype parameters basing on the known or those of interest psychophysiological peculiarities and character traits, for example when composing a photo-robot (identikit).

The present method can be realized with application of existing technical devices, approaches and methods, and it can be combined with possible tools that can be developed in the future.

The versions of realization of the present invention are in no way limited to the above versions of realization of the method according to the invention, they are only given to illustrate the essence of the invention. The scope of protection of the invention is determined by the claims.

1. Method for prognosticating at least one of behavior and activity type of a person, and for identifying personality, which includes parametric analysis of the phenotype of a person and concluding on the basis of the results obtained, characterized in that the method comprises;
measuring at least one parameter of any part of the phenotype;
and correlating the results of measuring, at least by means of simulation, with at least one of psychophysiological and physical possibilities of said part of the phenotype to fulfill at least one function which can be realized by said part of phenotype;
and concluding is done on the basis of the results of said correlating, about at least one of predisposition of said person to certain type of behavior, to forming certain compensatory social-and-psychological traits of character, and to certain type of activity.

2. Method according to claim 1, characterized in that it comprises
measuring at least two parameters of at least one phenotype part;
and comparing the results of correlating the results of measuring said parameters of at least one part of phenotype with possibilities of said part of phenotype to fulfill at least one function which can be realized by said part;
and concluding is done on the basis of the results of said comparing.

3. Method according to claim 1, which is characterized in that it comprises
measuring at least one parameter of phenotype of representatives of at least one population group;
and concluding is done about at least one of predisposition of said population group to certain type of behavior, to forming certain compensatory social-and-psychological traits of character, and to certain type of activity.

4. Method according to claim 2, which is characterized in that it comprises
measuring at least one parameter of phenotype of representatives of at least one population group;
and concluding is done about at least one of predisposition of said population group to certain type of behavior, to forming certain compensatory social-and-psychological traits of character, and to certain type of activity.
